(19) United States
(12) Patent Application Publication
(10) Pub. No.: US 2006/0197071 A1
(43) Pub. Date: Sep. 7, 2006

(54) STRAP TENSER

(76) Inventor: Han-Ching Huang, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/906,717

(22) Filed: Mar. 3, 2005

(51) Int. Cl. B25B 25/00

(52) U.S. Cl. 254/217

(57) ABSTRACT

A strap tenser includes a frame connected with a first strap. A reel is rotationally installed on the frame for reeling a second strap. At least one ratchet wheel is secured to the reel. A first detent is movably installed on the frame between an operative position where it engages with the ratchet wheel and an idle position where it leaves the ratchet wheel. A handle is pivotally installed on the reel. A second detent is movably installed on the reel between an operative position where it engages with the ratchet wheel so that the handle is operable to rotate the reel and an idle position where it leaves the ratchet wheel. A spiral spring includes a first end connected with an end of the reel and a second end connected with the frame or the handle for automatically rotating the reel when the first and second detents are in the idle position.

### BACKGROUND OF INVENTION

1. Field of Invention

The present invention relates to a strap tenser and, more particularly, to a strap tenser with an automatic strap-reeling device.

2. Related Prior Art

In U.S. Pat. No. 6,609,275, a strap-tightening apparatus includes an auto-pulling device 10 connected with a U-shaped seat 60. The auto-pulling device 10 includes a housing 11 and a reversing device 12. The reversing device 12 is put rotationally in the housing 11. The reversing device 12 includes a reel 121 and a spiral power spring 122. The reel 121 is put rotationally in the housing 11. An end of a strap 30 is attached to the reel 121 so that the strap 30 can be wound about the reel 121. The spiral power spring 122 is put in the housing 11. The spiral power spring 122 includes a first end secured to the housing and a second end secured to an internal periphery of the reel 121. Thus, the strap 30 can automatically be wound around the reel 121. The auto-pulling device 10 is however bulky because the diameter thereof is big since the spiral power spring 122 is located in the reel 121.

The present invention is therefore intended to obviate or at least alleviate the problems encountered in prior art.

### SUMMARY OF INVENTION

According to the present invention, a strap tenser includes a frame connected with a first strap. A reel is rotationally installed on the frame for reeling a second strap. At least one ratchet wheel is secured to the reel. A first detent is movably installed on the frame between an operative position where it engages with the ratchet wheel and an idle position where it leaves the ratchet wheel. A handle is pivotally installed on the reel. A second detent is movably installed on the reel between an operative position where it engages with the ratchet wheel so that the handle is operable to rotate the reel and an idle position where it leaves the ratchet wheel. A spiral spring includes a first end connected with an end of the reel and a second end connected with the frame or the handle for automatically rotating the reel when the first and second detents are in the idle position.

The primary advantage of the strap tenser of the present invention is its small size because the spiral spring is located beside, not inside, the reel and therefore allows the diameter of the reel to be small.

Other advantages and novel features of the invention will become more apparent from the following detailed description in conjunction with the attached drawings.

### BRIEF DESCRIPTION OF DRAWINGS

The present invention will be described through detailed illustration of the preferred embodiment referring to the drawings.

FIG. 1 is a perspective view of a strap tenser according to the preferred embodiment of the present invention.

FIG. 2 is an exploded view of the strap tenser shown in FIG. 1.

FIG. 3 is a side view of the strap tenser shown in FIG. 1 used together with two straps.

FIG. 4 is similar to FIG. 3 but shows the strap tenser in a different position.

FIG. 5 is similar to FIG. 4 but shows the strap tenser in a different position.

### DETAILED DESCRIPTION OF PREFERRED EMBODIMENT

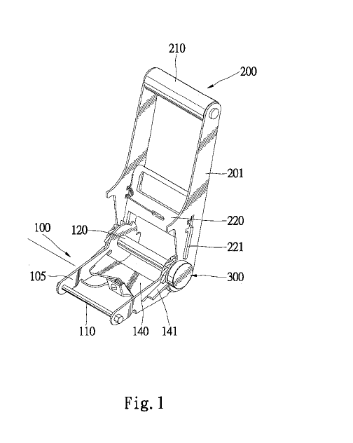

Referring to FIG. 1, according to the preferred embodiment of the present invention, a strap tenser includes a frame 100, a handle 200 and an automatic reeling device 300.

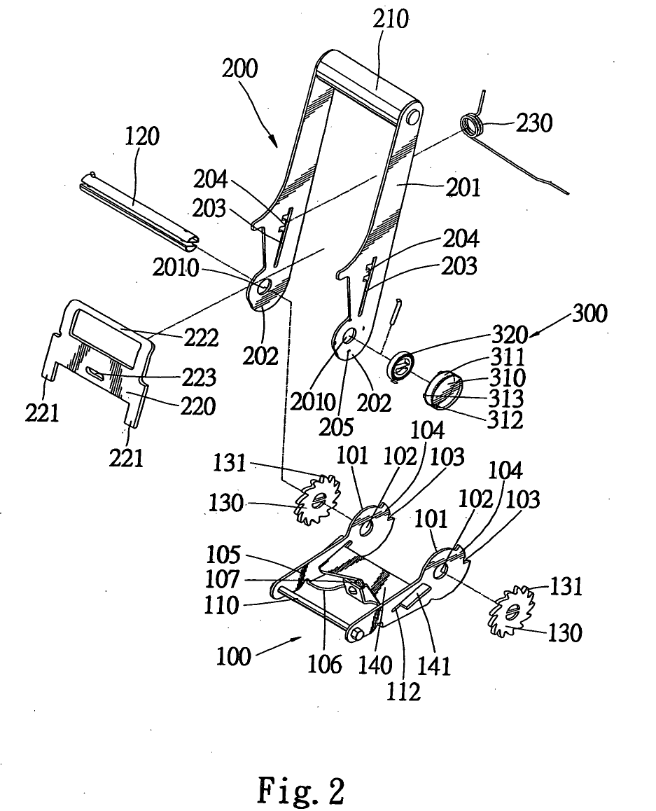

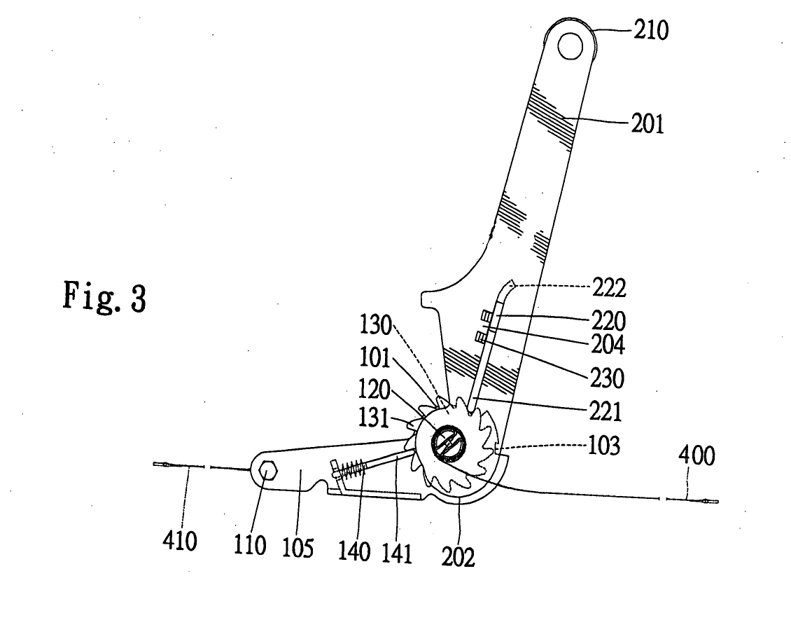

Referring to FIGS. 2 and 3, the frame 100 includes two side members 105 and a cross member 106 formed between the side members 105. Each side member 105 includes a middle section, a first end and a second end. Each side member 105 includes a slot 112 defined substantially in the middle section, an aperture 102 in the first end, a first arched edge 101 formed at the first end, a second arched edge 104 formed at the first end further from the aperture 102 than the first arched edge 101 and a recess 103 defined in the second arched edge 104.

A first detent 140 includes two flanks put movably in the slots 104 and two teeth 141 formed at the flanks and put outside the side members 105. A spring 107 is compressed between the first detent 140 and the cross member 106. Thus, the teeth 141 are engaged with the ratchets 131.

A rod 110 is provided between the side members 105. More particularly, the rod 110 extends to the second end of a side member 105 to the second end of the other side member 105.

A reel 120 is inserted in the apertures 102. Two ratcheted wheels 130 are secured to the reel 120 and located outside the side members 105. Each ratcheted wheel 130 includes a plurality of ratchets 131.

The handle 200 includes two levers 201 and a grip 210 provided between the levers 201. Each lever 201 includes a first end and a second end. Each lever 201 includes an aperture 201 defined in the first end for receiving an end of the reel 120, a cam 202 formed at the first end, a slot 203 defined therein near the first end and a tab 204 formed thereon near the slot 203. The grip 210 extends to the second end of a lever 201 from the second end of the other lever 201.

A second detent 220 includes two flanks, two teeth 221 formed on the flanks and put movably in the slots 203, a grip 222 formed at an end and a slot 223 defined therein. A spring 230 includes a spiral portion put on a tab 204, an end put in the slot 223 and another end put against a lever 201. Thus, the teeth 221 are engaged with the ratchets 131.

The automatic reeling device 300 includes a spiral spring 320 and a cap 310 for capping the spiral spring 320. The spiral spring 320 includes and a first end secured to the reel 120 and a second end to be described. The cap 310 includes a wall 311, a tab 312 formed on the interior of the wall 311 and a plurality of anchors 313 extending from the wall 311. The second end of the spiral spring 320 is bent for hooking the tab 312 of the cap 310. The anchors 313 are fit in a corresponding number of apertures 205 defined in the first end of the lever 201. Thus, the cap 310 is secured to the first end of a lever 201.

A first strap 401 includes an end connected with a first hook (not numbered) and an opposite end connected with the rod 110. A second strap 400 includes and end connected with a second hook (not numbered) and an opposite end connected with the reel 120. The second strap 400 is wound about the reel 120.

In use, the second strap 400 is reeled out from the reel 120. When the second strap 40 is reeled out from the reel 120, the spiral spring 320 is stressed. The first and second hooks are hooked to objects. The handle 200 is operated to tense the straps 410 and 400. The operation of the handle 200, the second detent 220, the ratcheted wheels 130, the reel 120 and the first detent 140 is conventional and will not be described further in detail.

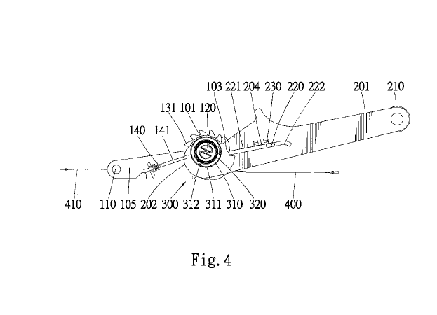

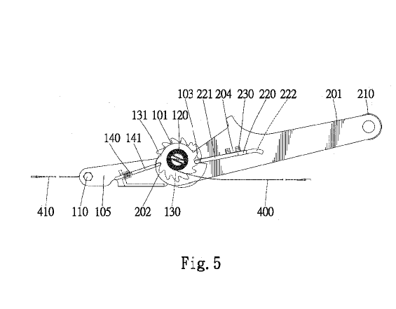

Referring to FIGS. 4 and 5, to reel out the second strap 400, the handle 200 is pivoted to a position almost opposite to the frame 100. The cams 202 push the teeth 141 from the ratchets 131. The grip 222 is operated in order to pull the second detent 200. The teeth 221 are moved to the second arched edges 104 from the first arched edges 101. The grip 222 is released so that the teeth 221 are put in the recesses 103 because of the torque spring 230. Thus, the teeth 221 are kept from the ratchets 131. Hence, the reel 120 can be rotated freely except for hindered by the spiral spring 320. That is, the second strap 400 can be reeled out.

Once the second hook is released, the spiral spring 320 functions to reel in the second strap 400. However, torque by the spiral spring 320 may not overcome the resistance from the first detent 140 and the second detent 220. Therefore, it would be better to take the process described above referring to FIGS. 4 and 5.

The present invention has been described via detailed illustration of the preferred embodiment. Those skilled in the art can derive variations from the preferred embodiment without departing from the scope of the present invention. Therefore, the preferred embodiment shall not limit the scope of the present invention defined in the claims.

1. A strap tenser comprising:
a frame connected with a first strap;
a reel rotationally installed on the frame for reeling a second strap;
at least one ratchet wheel secured to the reel;
a first detent movably installed on the frame between an operative position where it engages with the ratchet wheel and an idle position where it leaves the ratchet wheel;
a handle pivotally installed on the reel;
a second detent movably installed on the handle between an operative position where it engages with the ratchet wheel so that the handle is operable to rotate the reel and an idle position where it leaves the ratchet wheel; and
a spiral spring comprising a first end connected with an end of the reel and a second end connected with one of the frame and the handle for automatically rotating the reel when the first and second detents are in the idle position.

2. The strap tenser according to claim 1 comprising a cap for capping the spiral spring.

3. The strap tenser according to claim 2 wherein the cap comprises a wall secured to the handle.

4. The strap tenser according to claim 3 wherein the spiral spring comprises a first end secured to the reel and a second end secured to the wall.

5. The strap tenser according to claim 4 wherein the cap comprises a tab formed on the wall, wherein the second end of the spiral spring is bent for hooking the tab.

6. The strap tenser according to claim 3 wherein the cap comprises a plurality of anchors extending from the wall, wherein the handle defines a plurality of apertures for receiving the anchors.

7. The strap tenser according to claim 1 wherein the handle can be pivoted between a first position and a second position where it moves the first detent to the idle position.

8. The strap tenser according to claim 7 wherein the handle comprises at least one cam for pushing the first detent.

9. The strap tenser according to claim 7 wherein the frame comprises a first arched edge formed thereon and a second arched edge located next to and further from the reel for keeping the second detent from the ratchet wheel when the handle is in the second position.

10. The strap tenser according to claim 9 wherein the frame defines a recess in the second arched edge for receiving the second detent.
